(19) United States
(12) Patent Application Publication
(10) Pub. No.: US 2009/0033404 A1
(43) Pub. Date: Feb. 5, 2009

(54) Broadband cascode mixer

(75) Inventors: Yi-Jen Chan, Jhongli City (TW); Kung-Hao Liang, Taipei City (TW); Hong-Yeh Chang, Zhonghe City (TW)

Correspondence Address: TROXELL LAW OFFICE PLLC;SUITE 1404, 5205 LEESBURG PIKE, FALLS CHURCH, VA, 22041, US

(73) Assignee: National Central University, Taoyuan (TW)

(21) Appl. No.: 12/076,708

(22) Filed: Mar. 21, 2008

(30) Foreign Application Priority Data
Aug. 2, 2007 (TW) 096128330

(51) Int. Cl. G06G 7/16

(52) U.S. Cl. 327/356

(57) ABSTRACT

A mixer has a cascode configuration. With the configuration, the mixer is operated under a low voltage. And, the present invention has a good circuit gain, a good broadband operation and a low power consumption. The mixer can be realized with a CMOS transistor. Hence, the present invention is fit to be applied in a receiver module.

### FIELD OF THE INVENTION

The present invention relates to a mixer; more particularly, relates to a mixer having a good circuit gain a good broadband operation, a low voltage and a low power consumption.

### DESCRIPTION OF THE RELATED ART

Following improvements in semiconductor technologies, related physical components become faster and consume littler power. And thus minimized integrated chip can be designed. A low power consumption is a very important requirement in a wireless communication system, which not only prolongs a battery life time but also reduces a weight of a transceiver module for wider and easier applications.

As shown in FIG. 6, a receiver module 6 is an important circuit at a radio frequency port of a wireless communication chipset, comprising sub-circuits of a power amplifier 61, a low noise amplifier 62, a mixer 63 and a voltage control oscillator 64. Therein, the mixer 63 plays an important role that low-frequency signals or high-frequency signals are heightened or lowered in their signal frequencies by local oscillation frequencies to be used in a receiver. Hence, performance of the receiver module 6 is affected by the quality of the mixer 63.

As shown in FIG. 7, A Gilbert-cell mixer 7 revealed in U.S. Pat. No. 4,156,283 is a general active mixer comprising six transistors. Therein, a first transistor 712 and a second transistor 711 are used as an input transconductance stage 71, which transforms voltage signals to current signals; a third transistor 721, a fourth transistor 722, a fifth transistor 723 and a sixth transistor 724 are used as a switching stage 72 to switch between opening and closing. At output ends, output resistors 73 transform current signals to voltage signals as final intermediate frequency signals to be outputted. An operational current required for the circuit of the Gilbert-cell mixer 7 is about 1˜10 mA; yet, because a complementary metal-oxide-semiconductor (CM OS) transistor needs 0.18 μm, the Gilbert-cell mixer 7 usually needs 1 volt for circuit control.

Regarding the operational voltage and the power consumption, the Gilbert-cell mixer 7 has a circuit with a high voltage gain and a broadband operation but it does not operated with a low voltage and a low power consumption. Hence, the prior art does not fulfill all users' requests on actual use.

### SUMMARY OF THE INVENTION

The main purpose of the present invention is to provide a mixer having a good circuit gain, a good broadband operation, a low voltage and a low power consumption to effectively reduce a required power consumption.

Another purpose of the present invention is to realize the mixer with a low-cost commercial CMOS transistor.

To achieve the above purposes, the present invention is a broadband cascode mixer, comprising an LO-injection switching stage, an RF transconductance stage, an output active load and an output buffer, where the LO-injection switching stage is injected with alternating LO signals from bodies of transistors to switch opening and closing of the transistors with threshold voltages of the transistors; the RF transconductance stage amplifies RF signals of voltage inputted and transforms the RF signals of voltage into signals of current; the output active load has an effective impedance, changes resistance with bias voltage, and transforms the signals of current into voltage signals having intermediate frequencies; the output buffer receives the voltage signals having intermediate frequencies generated after operations of circuits of the output active load at outputs of the RF transconductance stage; and all of the voltage signals having intermediate frequencies obtained by amplifying down-converted signals are outputted at one time after impedance matching. Accordingly, a novel broadband cascode mixer is obtained.

### BRIEF DESCRIPTION OF THE DRAWINGS

The present invention will be better understood from the following detailed description of the preferred embodiment according to the present invention, taken in con junction with the accompanying drawings, in which

FIG. 1 is the structural view showing the preferred embodiment according to the present invention;

FIG. 2 is another structural view showing the preferred embodiment;

FIG. 3 is the view showing modulating the LO signal through the threshold voltage;

FIG. 4 is the view showing the isolation comparison;

FIG. 5 is the view showing the measurement of the simulation;

FIG. 6 is the view of the general receiver module and

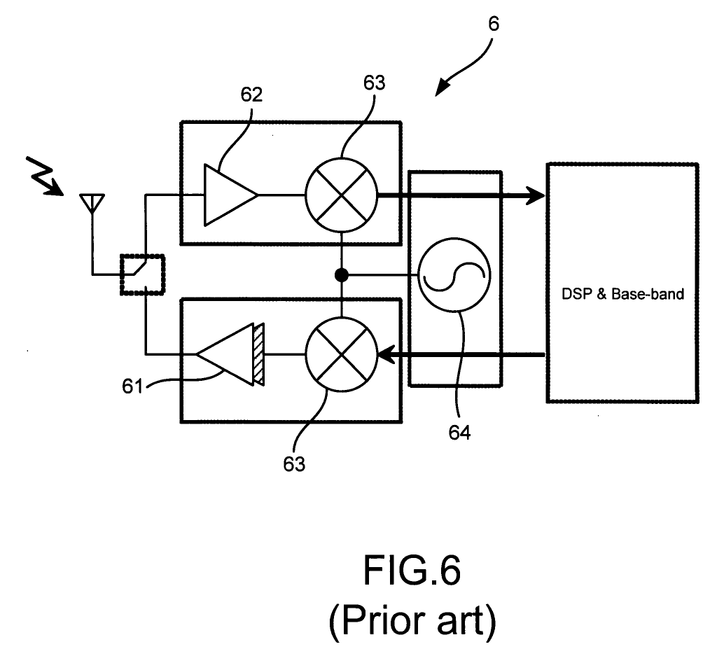

FIG. 7 is the structural view of the general mixer.

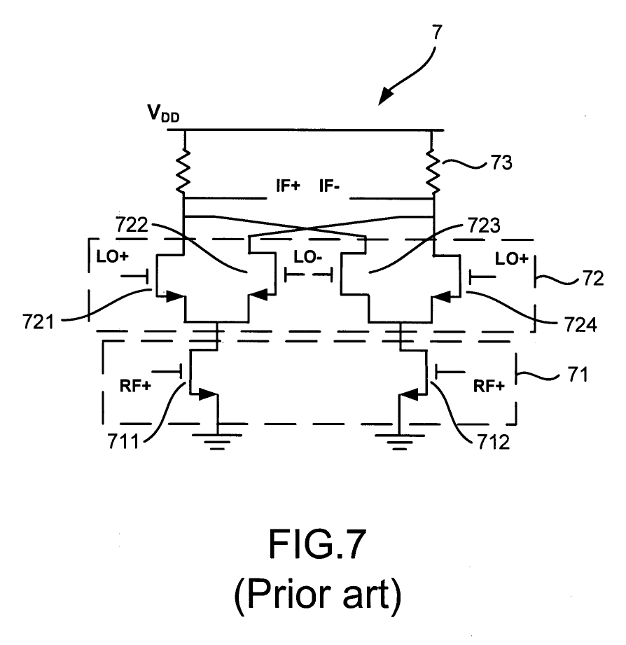

### DESCRIPTION OF THE PREFERRED EMBODIMENT

The following description of the preferred embodiment is provided to understand the features and the structures of the present invention.

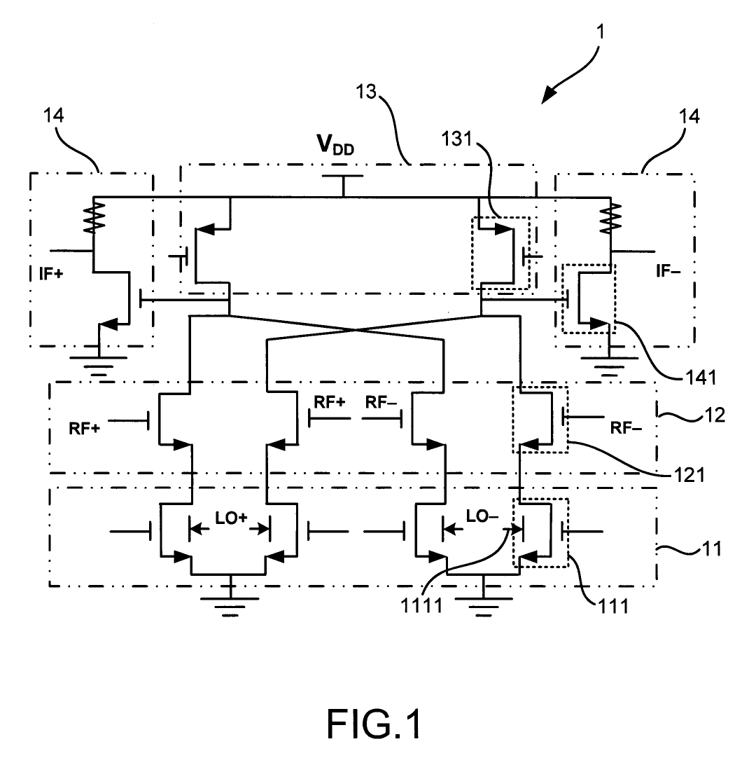

Please refer to FIG. 1, which is a structural view showing a preferred embodiment according to the present invention. As shown in the figure, the present invention is a broadband cascode mixer 1, comprising an LO-injection switching stage 11, an RF transconductance stage 12, an output active load 13 and an output buffer 14.

The LO-injection switching stage 11 has a plurality of transistors 111, where the LO-injection switching stage 11 has a bias voltage smaller than a threshold voltage of the transistor of the LO-injection switching stage; and bodies 1111 of the transistors are injected with alternating LO signals to switch opening and closing of the transistors with the threshold voltages of the transistors. The RF transconductance stage 12 amplifies RF signals of voltage inputted and transforms the RF signals of voltage into signals of current. The output active load 13 has an effective impedance; the output active load 13 changes resistance with bias voltage; and, the output active load 13 transforms the signals of current into voltage signals having intermediate frequencies. The output buffer 14 receives the voltage signals having intermediate frequencies gene rated after operations of circuits of the output active load 13 at outputs of the RF transconductance stage 12; and all of the voltage signals having intermediate frequencies obtained by amplifying down-converted signals or up-converted signals are outputted at one time after impedance matching. Therein, both the LO-injection switching stage 11 and the RF transconductance stage 12 comprise a p-channel metal oxide semiconductor (pMOS) transistor and an n-channel metal oxide semiconductor (nMOS) transistor. The output active load 13 is a resistor, an inductor or a transistor; and the transistor is a metal oxide semiconductor (MOS) transistor. The output buffer has a common-gate (C G configuration, a common-source (CS) configuration or a common-drain (CD) configuration. The mixer comprises a single-end circuit, a single-balance circuit or a double-balance circuit. The broadband cascode mixer 1 outputs the down-converted signals or the up-converted signals, where the down-converted signal is obtained from a frequency difference between an RF signal and an LO signal and the up-converted signal is obtained from a sum of frequencies of an RF signal and an LO signal. With the above structure, a novel broadband cascode mixer is obtained.

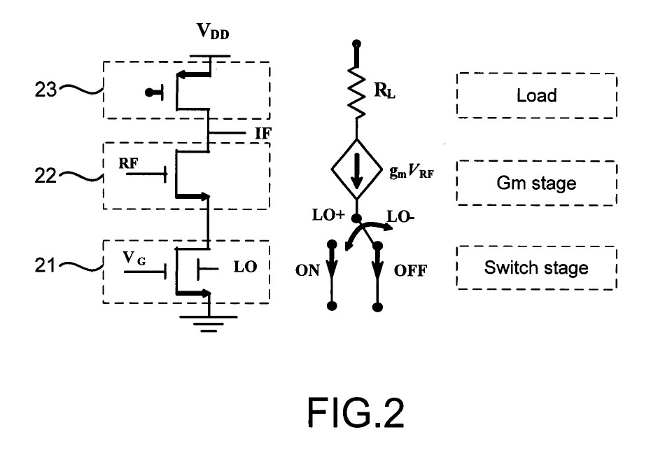

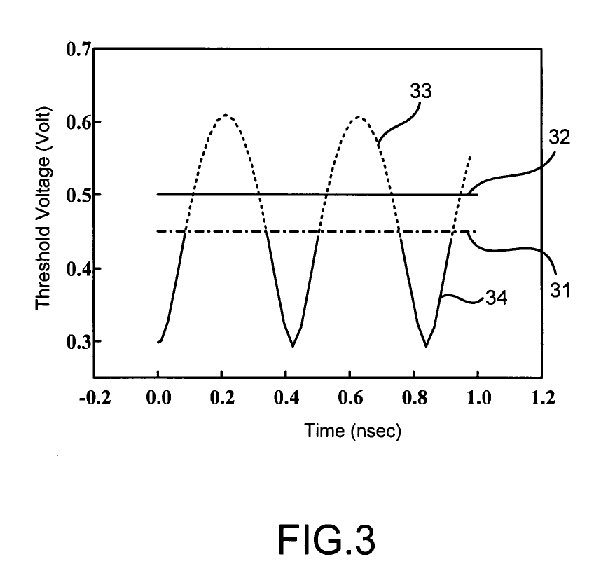

Please refer to FIG. 2 and FIG. 3, which is another structural view showing the preferred embodiment and a view showing modulating a LO signal through a threshold voltage. As shown in the figures, on using the present invention, an LO signal is injected from a body of a first transistor 21; and a gate voltage 31 is smaller than a threshold voltage 32 of the first transistor 21. When the LO signal is not injected, the first transistor 21 is closed and no power is consumed. On injecting the LO signal from the body of the first transistor 21, a voltage difference is formed between a source of the first transistor 12 and the body of the first transistor 12; and is changed with the LO signal of sine wave or square wave. Thus, the fixed gate voltage 31 is sometimes bigger or sometimes smaller than the threshold voltage 31 of the first transistor 21. When the first transistor 21 is in a positive period of the LO signal, a state-of-close curve 33 is shown. On the contrary, when the first transistor 21 is in a negative period of the LO signal, a state-of-open curve 34 is shown. Thus, the first transistor 21 becomes a switching stage controlled by the LO signal injected from the body and is characterized in a low current.

A second transistor 22 of an RF transconductance stage has a bias voltage in a saturation region to obtain a good transconductance and further amplifies an RF signal inputted. At last, a third transistor 23 of an output active load is a pMOS transistor. The third transistor 23 has a bias voltage in a saturation region to obtain a big output resistance and further in creases a circuit gain of the present invention. Thus, best characteristics are obtained when the first transistor 21 is operated in a linear region, the second transistor 22 the saturation region and the third transistor 23 the saturation region.

In addition, the second transistor 22 of the RF transconductance stage is stacked on the first transistor 21 of the LO-injection switching stage 11 to reduce voltage drop in every stage for operating the present invention at around 0.7 volts. Hence, the present invention has a low power consumption and a low voltage on operation.

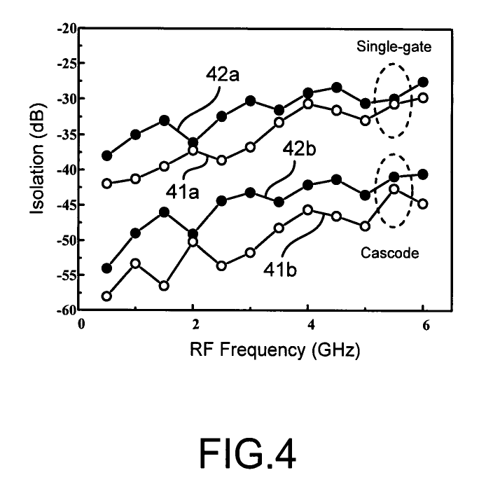

Please refer to FIG. 4, which is a view showing an isolation comparison. As shown in the figure, an RF transconductance stage is interchanged with an LO-injection switching stage to improve isolation between an RF port and an LO port. In measurements of RF-LO isolation curves 41a,41b and LO-RF isolation curves 42a,42b, a single transistor has an isolation about 30 dB between the RF isolation curve and the LO isolation curve 41a,42a; and, a cascode configuration has an increased isolation about 50 dB between the RF isolation curve and the LO isolation curve 41b,42b. As a result, an improvement of 20 dB is obtained.

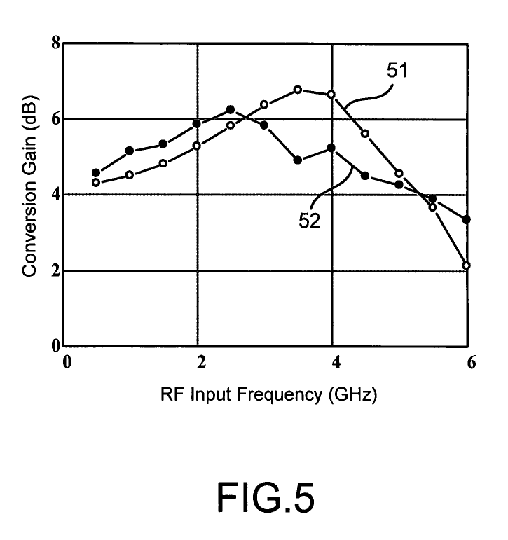

Please refer to FIG. 5, which is a view showing a measurement of a simulation. As shown in the figure, the present invention has a 3-dB broadband operation. In a measurement of a simulation curve 42 and a measuring curve 52, it is shown that the 3-d B broadband operation has a bandwidth about 5.5 GHz, which has quite a wide operational bandwidth on comparing to other circuits.

Consequently, the broadband cascode mixer according to the present invention has a low voltage, a low power consumption, high RF-LO and LO-RF isolations, and a 3-dB broadband operation for RF frequency inputs, which is fit for inner circuits of a receiver module with a reduced power consumption. Besides, a circuit of the present invention can be realized as a commercial complementary metal-oxide-semiconductor (CMOS) transistor with an operational frequency ranging from several MHz to several GHz. Under such an operational frequency, the present invention is a stable circuit with a low voltage and a low power consumption.

To sum up, the present invention is a broadband cascode mixer, which is good at circuit gain and broadband operation with a low voltage and a low power consumption to be applied in circuits of a receiver module.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A broadband cascode mixer, comprising:
an LO-injection switching stage, said LO-injection switching stage having a plurality of transistors, bodies of said transistors being injected with LO signals, opening and closing of said transistors being switched with threshold voltages of said transistors;
an RF transconductance stage, said RF transconductance stage amplifying RF signals of voltage, said RF transconductance stage transforming said RF signals of voltage into signals of current;
an output active load, said output active load having an effective impedance, said output active load changing resistance with bias voltage; and
an output buffer, said output buffer receiving signals generated after operations of circuits at outputs of said RF transconductance stage, said output buffer amplifying said signals, said signals being selected from a group consisting of down-converted signals and up-converted signals.

2. The mixer according to claim 1,
wherein both said LO-injection switching stage and said RF transconductance stage comprise a p-channel metal oxide semiconductor (pMOS) transistor and an n-channel metal oxide semiconductor (nMOS) transistor.

3. The mixer according to claim 1,
wherein said output active load is selected from a group consisting of a resistor, an inductor and a transistor.

4. The mixer according to claim 3,
wherein said transistor is a metal oxide semiconductor (MOS) transistor.

5. The mixer according to claim 1
wherein said output buffer has a configuration selected from a group consisting of a common-gate (CG) configuration, a common-source (CS) configuration and a common-drain (CD) configuration.

6. The mixer according to claim 1,
wherein a cascode is obtained with said LO-injection switching stage and said RF transconductance stage.

7. The mixer according to claim 6,
wherein said LO-injection switching stage and said RF transconductance stage are interchangeable.

8. The mixer according to claim 1,
wherein said LO-injection switching stage has a bias voltage smaller than a threshold voltage of said transistor of said LO-injection switching stage.

9. The mixer according to claim 1,
wherein said LO signal has a wave selected from a group consisting of a sine wave and a square wave.

10. The mixer according to claim 1
wherein said mixer comprises a circuit selected from a group consisting of a single-end circuit, a single-balance circuit and a double-balance circuit.

11. The mixer according to claim 1,
wherein said mixer outputs signals selected from a group consisting of said down-converted signals and said up-converted signals.

12. The mixer according to claim 11,
wherein said down-converted signal is obtained from a frequency difference between an RF signal and an LO signal.

13. The mixer according to claim 11
wherein said up-converted signal is obtained from a sum of frequencies of an RF signal and an LO signal.
